(19) United States
(12) Patent Application Publication
(10) Pub. No.: US 2004/0056890 A1
(43) Pub. Date: Mar. 25, 2004

(54) Method and system for provisioning mobile device machine interfaces

(76) Inventors: Ying Hao, Novi, MI (US); Larry Joseph Mitchell, Toronto (CA)

Correspondence Address: HOGAN & HARTSON LLP, ONE TABOR CENTER, SUITE 1500, 1200 SEVENTEEN ST., DENVER, CO, 80202, US

(21) Appl. No.: 10/247,134

(22) Filed: Sep. 19, 2002

(51) Int. Cl. G09G 5/00

(52) U.S. Cl. 345/744; 345/700

(57) ABSTRACT

A human machine interface system for use in computer systems in mobile and non-mobile clients. The system divides functions required to provide a user interface into a user interface unit that is a thin client with a rendering engine for creating user interfaces from user interface descriptors and a hosting platform with an interface application that processes user input and transmits presentation instructions to the rendering engine, which executes the instructions to alter the user interface. A set of rules for creating user interface descriptors and methods and protocols for communicating between the hosting platform and the user interaction unit are provided along with a provisioning system that enhances initial creation of user interfaces and the provisioning of interfaces to clients in a manner that facilitates compatibility and consistency among clients using interfaces while allowing flexibility to make unique or branded interfaces by providing sets of vendor signatures.

### BACKGROUND OF THE INVENTION

1. Field of the Invention

The present invention relates, in general, to pervasive computing systems and methods of interfacing between a human user and a computer or machine, and, more particularly, to software, systems, and methods for facilitating the development of user interfaces that allows ready provisioning and installation in new and existing computer systems, such as mobile computer systems or networks including in-vehicle systems, and to a method and system for providing a human machine interface (HMI) within the computer system including a host platform to perform complex interface processes and a thin client interface unit rendering the user interface and receiving user input.

2. Relevant Background

In the computer and information technology industry, the demand is rapidly growing for pervasive computing that allows people ubiquitous or ongoing access to information and services through the use of portable computers and wired and wireless networking. In the automobile industry alone, telematics is projected to become a $20-billion industry within the next decade. Telematics is a term used to describe the hardware and software technologies used to provide in-vehicle (or on-client for non-mobile implementations) multimedia, and infotainment. Telematics technologies include a number of functional areas including vehicle integration, remote vehicle services, and near vehicle interaction. Vehicle integration technologies or services provide enhanced control of vehicle operations including heating and ventilation, entertainment systems, ongoing diagnostics, and the like. Remote vehicle services include wireless Internet access and the providing of Internet-based services commonly available for desktop computers such as e-mail messaging, calendaring, commerce, and streaming media via cell-based network protocols (e.g., CDMA, GSM, GPRS, WCDMA, and the like). Near vehicle interaction includes services such as smart highways, tolls, gas pump-based services, and vehicle-to-vehicle safety systems (e.g., collision detection and avoidance).

Each mobile client, such as an automobile or mobile computer or computing platform, includes a computing device often called a human machine interface (HMI) to provide a user interface allowing users (such as drivers and passengers) to access the computer system (such as an in-vehicle system) and operate on-board devices and access telematic services. The use and availability of telematics in vehicles (or other mobile clients) such as automobiles, boats, airplanes, and mobile or wireless computers and in homes and businesses (or non-mobile clients) is expected to continue to grow rapidly in the future but such growth will be hindered as long as customers perceive telematics as an expensive and impractical toy.

While the market has continued to grow, telematics has often been a money loser for companies. One reason that telematics have not been profitable is that there is no industry model and very little if any standardization, which leads to multiple and often very different and typically incompatible solutions being provided for each telematics application. For example, in the automotive industry, each vehicle manufacturer desires to have their telematics have a unique look and feel and to provide different functionality then competitors' systems, but this often makes it difficult for third party vendors of content and of applications to efficiently develop and provide content and applications to each of the manufacturers as they may need to start over for each manufacturer. The control portion of the in-vehicle computer system communicates content and instructions to the user interface devices and the communication rules or protocols often vary significantly among the vehicle manufacturers. The developer of an application is forced to know in detail each vehicle's telematics technologies (hardware, software, and communication protocols) including the particular user interface or interfaces (e.g., HMIs) employed by the vehicle manufacturer and to develop their application for that set of technologies.

Standardization of parts has often driven design efforts in the auto industry but so far, standardization has not been applied to the in-vehicle computer system or to the HMI or user interface. The typical vehicle design cycle is typically a few years making it difficult to design an HMI module that is flexible enough to address all potential needs of the work-in-progress vehicle. Many vehicles (and non-mobile clients) include more than one interface between the user and the computer system which complicates the task of trying to design a single HMI module useful for all vehicles let alone a single vehicle with multiple interfaces that each typically have different uses and interaction needs (e.g., a touch screen versus a speech recognition interface).

Faced with the large diversity of functional demands and architectural challenges, most vendors have addressed the problem by providing a single mechanism that integrates telematic functions and interfaces with the user. In the auto industry, such devices are often called telematics control unit or a telematics communications unit (TCU) that is typically a robust computing unit suited to the harsh automotive environment and connected to a central service center providing telematics services to the vehicle and, in some cases, to the engine control unit or on-board computer that allows the user to access other on-board services. In some implementations, the TCU is a one-box-fits-all personal computer that includes a graphical user interface (GUI) and some reasonable voice recognition capabilities. Typically, this TCU provides radio/CD/tuner integration, climate control, e-mail messaging, and navigation capabilities. In other implementations, the TCU is considered a vehicle service provider model that is securely connected to a remote service provider. The vehicle owner generally signs up for a service account and services in the form of software packages are deployed to the TCU including off-board navigation using GPS, driver assistance, e-mail messaging, media capabilities and more. While providing some consistency within a particular line of manufacturers of vehicles, these solutions are based on the premise that all vehicles are basically the same and require the same functionality and interfaces. Also, these TCUs are generally expensive and are only implemented in the most expensive vehicle models and brands. In order for pervasive computing to be more readily accepted in vehicles and in non-mobile clients, the TCUs and/or other telematics have to be flexible to provide and support a wide variety of functions and scalable in terms of price and/or performance to allow their use in a wider range of applications (such as less expensive automobiles).

Hence, there remains a need for an improved method and system for use in mobile clients or mobile computing platforms, such as automobiles, boats, airplanes, and mobile computers and computing devices, and in non-mobile clients, such as homes and businesses, to provide services and information that facilitate pervasive computing. Preferably, such a method and system would increase the flexibility of providing content and applications by increasing the flexibility of the human machine interface (HMI) while lowering the cost of updating the user interface and adding new user interfaces. Additionally, such a method and system preferably would reduce the complexity and cost of developing and provisioning or providing content, applications, and user interfaces to mobile and non-mobile clients incorporating a pervasive computing environment such as telematics systems in automobiles.

### SUMMARY OF THE INVENTION

The present invention addresses the above problems by providing a human machine interface system for use in on-board computer networks or systems in mobile clients, such as in vehicles and in mobile computing platforms and devices, and in non-mobile clients, such as homes and businesses. The system divides functions required to provide a user interface into a user interface unit (or HMI device) that is a thin client including a rendering engine for creating user interfaces from a user interface descriptor and a hosting platform that runs an underlying HMI application to process user input and to transmit presentation instructions to the rendering engine to alter the displayed user interface. The invention further provides rules for creating user interface descriptors and corresponding HMI application(s) and provides methods and protocols for communicating between the hosting platform and the user interaction unit. The invention further provides a provisioning system and method that enhances the initial creation or generation of user interfaces and associated HMI applications by third parties and the provisioning or downloading of such interfaces to clients in a manner that facilitates compatibility and consistency among clients using such interfaces while allowing flexibility to make different vendors have different looks and feels to their user interfaces through the use of vendor signatures.

The human machine interface system and provisioning system have architectures expressly designed for building and deploying in-vehicle or on-client applications. The inventive systems reduce the required functionality of the user interaction unit or HMI by turning it generally into a simple engine handling presentation of user interfaces and information and handling or receiving user input. This simplification of the HMI unit lowers the barriers of entry for HMI products and reduces the cost of the overall in-vehicle system. The systems adopt standardization including calling for use of a markup language (e.g., eXtensible Markup Language (XML)) for the user interface descriptors produced by user interface developers and providers and for messaging between the hosting platform and the HMI unit. Such standardization expedites the development of in-vehicle or on-client applications and simplifies provisioning and deployment of these applications including new or modified user interfaces.

According to one aspect of the invention a user interface (UI) rendering engine resides on the user interaction unit. The UI rendering engine can be written in a native language to reduce its footprint and increase performance. Upon receiving a UI descriptor, the UI rendering engine processes it and generates a single or multiple model user interfaces based on availability of a display surface, a speech recognizer, or other interface tools, which is determined on the fly. At run time, the UI rendering engine handles simple user input by following the UI descriptor. For example, the UI rendering engine may act to switch screens. For more complex user inputs, the UI rendering engine constructs a user input message (such as an XML message) and sends it to an HMI application on the hosting platform for processing and then executes the presentation instructions received back from the hosting platform sent by the HMI application (e.g., display text messages, synthesize a voice message, change the displayed user interface, and the like). XML-based communication protocols or other similar messaging protocols are typically used for messaging within the human machine interface system because these protocols are independent of underlying transport protocols and third party application providers do not need any knowledge of how the hosting platform and the user interaction unit are connected. Further, XML-based communications support the use of synchronous and asynchronous messaging in the system and allow for the use of the document or message format definitions (such as by using document type definitions or DTDs).

The HMI application resides on the hosting platform which has more data storage and processing capacity and acts as a server to the thin client user interaction unit and its UI rendering engine. The HMI application implements key application logic of the human machine interface system and provides access to other on-board or vehicle services. The HMI application provisions UI descriptors received and stored on the hosting platform to appropriate user interaction units (as each mobile or non-mobile client device may have multiple user interaction units). The HMI application processes user input messages from the user interaction unit and constructs and transmits presentation instructions to the user interaction unit. To allow the HMI application to map raw user input sent from the user interaction unit to invocations of application functions, the HMI application maintains in hosting platform memory a detailed reference of the user interaction unit and the created user interface. A communication manager, which again may be written in a native language, is provided at both the hosting platform and the user interaction unit to handle receiving and sending of messages, such as XML messages including UI descriptors, user inputs, and UI presentation instructions.

More particularly, a computer-based method is provided for use in a mobile computing platforms (such as in-vehicle computer systems) and non-mobile client systems for providing user interfaces. The method includes providing a user interface rendering engine with a parser in a thin architecture human machine interface (HMI) device. A set of interface components defining user interface elements or constructs is stored on the HMI device. A user interface descriptor, such as an XML or other markup language document, is received that includes objects corresponding to a subset of the stored interface components. The method continues with parsing the user interface descriptor with the parser and then generating a user interface on the HMI device based on the parsed user interface descriptor and the set of interface components. Typically, the generating includes mapping the parsed objects to the set of interface components. The user interface is monitored for user input and when received, a user inputs message describing the raw user input is transmitted to a hosting platform with an HMI application for processing. The method continues with receiving a UI presentation instruction based on the transmitted user inputs message and then executing the instruction to alter the user interface. In one embodiment, the user inputs message and the UI presentation instruction are both XML-based messages understandable by the parser.

Further, a computer-based method is provided for providing a user interface in a mobile or non-mobile client. The method includes loading a human machine interface (HMI) application on a hosting platform in the client computer system that is communicatively linked to one or more user interaction units. A user interface descriptor is received from a source external to the client such as from a central service system over a wireless network. The user interface descriptor is transmitted from the host platform by the HMI application to an appropriate one of the user interaction units and defines user interface components for a user interface. In one embodiment, the user interface descriptor is an XML document with objects corresponding to the components that can be parsed by the user interaction unit and mapped to UI components stored in a repository on the user interaction unit. The method continues with receiving a message (such as XML-based message) from the user interaction unit providing a description of user input at the user interface generated by the user interaction unit based on the user interface descriptor. The message is processed by the HMI application based on a set of interaction rules or protocols and then the HMI application generates a user interface presentation instruction(s) that define modifications to the user interface. Generally, the set of interaction rules define responses to user inputs in user interfaces generated based on a particular user interface descriptor and the HMI application maintains a reference or link between user interface components and such defined responses. The instruction is then transmitted (such as in an XML-based message) to the user interaction unit for execution to alter the user interface. The method may further include transmitting a message or command to a shared service linked or on the client computer system for action by that service or requesting a response from such service for use in generating the instructions transmitted to the user interaction unit.

### BRIEF DESCRIPTION OF THE DRAWINGS

FIG. 1 illustrates in block diagram form a user interface provisioning system according to the present invention illustrating components for initial development of user interfaces and deployment to mobile and non-mobile clients with human machine interface functions divided between a user interaction unit and a hosting platform;

FIG. 2 is a flow chart illustrating functions performed during operation of the provisioning system of FIG. 1;

FIG. 3 illustrates an exemplary client interface system according to the present invention such as may be utilized in the client devices of the provisioning system of FIG. 1 that more fully shows the software and hardware components of hosting platforms and user interaction units (e.g., human machine interfaces (HMI)) that work in combination to provide user interfaces within a client (such as a vehicle) and to respond to user input; and

FIG. 4 is a flow chart illustrating functions performed by the client interface system of FIG. 3 in rendering and interacting with a user interface in a client using a thin architecture user interaction unit or HMI device and a hosting platform with greater data storage and processing capabilities.

### DETAILED DESCRIPTION OF THE PREFERRED EMBODIMENTS

The present invention is directed to addressing the problems and inflexibilities arising out of prior systems and method for providing user interfaces and applications in telematics environments, such as in-vehicle computer systems, including the typical use of one size fits all approaches to telematics control units (TCUs) which led to a number of problems (e.g., high cost, not scalable across vehicle or product lines, difficult to upgrade, and required higher performance memory and processor functionalities). The present invention recognizes the usefulness of implementing interface functionality in the telematics environment, and particularly in computer systems in mobile clients such as vehicles, in a two part or two box arrangement with one component being provided for user interaction (i.e., the user interaction unit or HMI unit) and one component being provided to act as a server or hosting platform for applications (i.e., the hosting platform running HMI and other applications for supporting the user interaction unit).

The hosting platform can be used in a wide variety of client systems because it is configured to require relatively inexpensive components (such as memory and processors) but be relatively generic or standardized in function. The user interaction unit can include components that differentiate by model and brand of a client (e.g., a vehicle or other mobile computing platform) such as by providing less functionality in less expensive clients or client product lines (such as by not providing full interface functionality) and providing fuller functionality in more expensive clients or client product lines (such as by providing speech recognition and other more costly or differing features to suit customer tastes and demands). In order to take full advantage of the separate user interaction unit, most embodiments of the invention provide a user interaction unit that is relatively or fully independent of its intended use by providing a user interface (UI) rendering engine on each user interaction unit that enables the hosting platform to provision received user interfaces to the UI rendering engine, which acts to install the user interface.

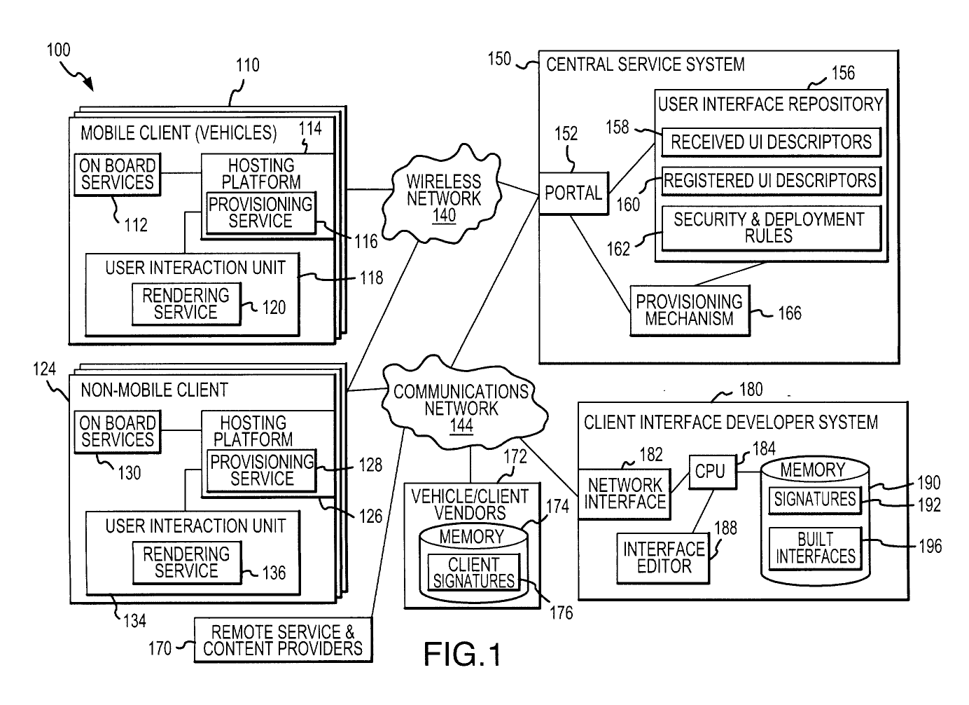

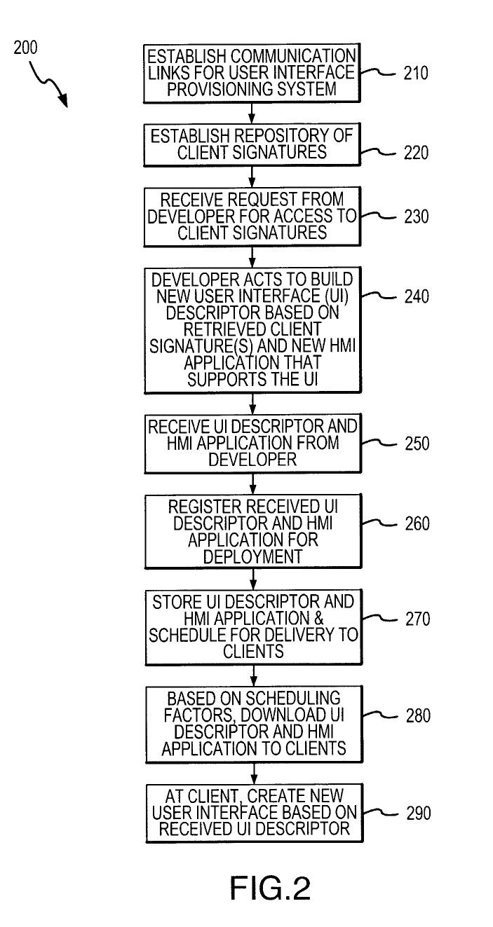

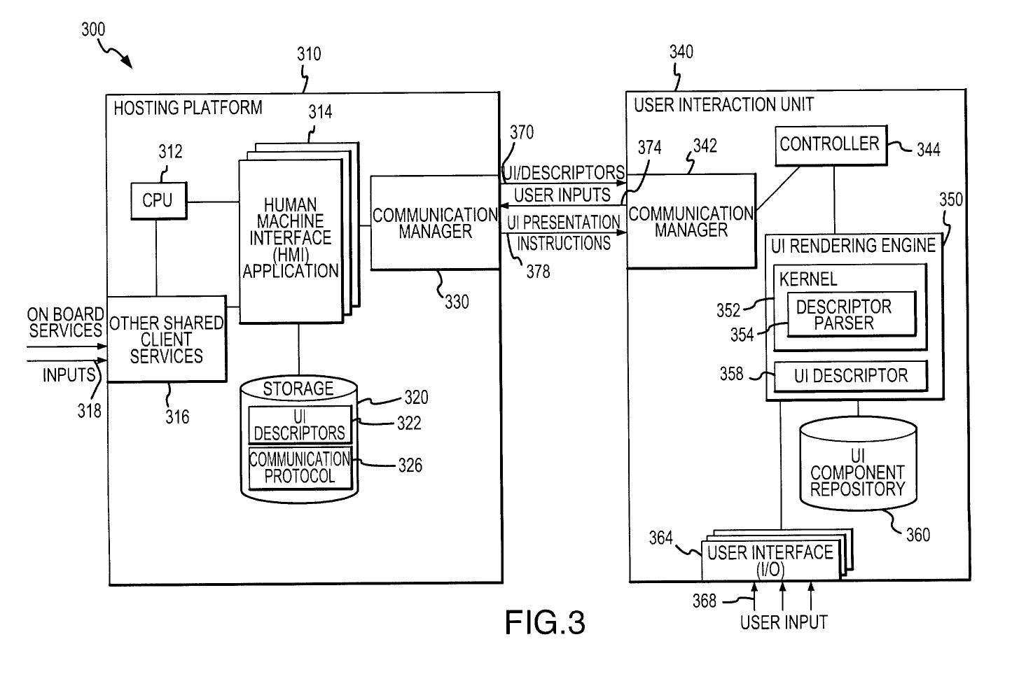

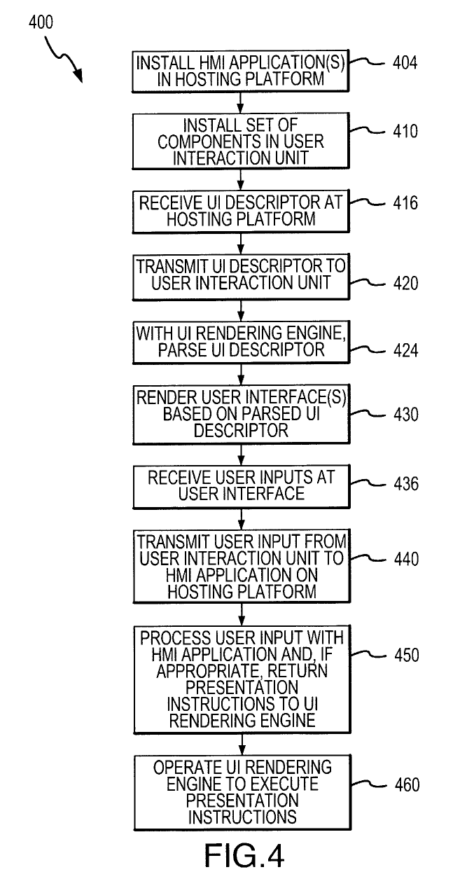

The following description begins with a discussion of a UI provisioning system (or application provisioning system) with reference to FIG. 1 and then proceeds to a discussion of a method of creating and provisioning user interfaces to client devices with reference to FIG. 2. The description proceeds to a more detailed description of the hosting platform and user interaction units of the present invention, operation of such these components, communication between these components, and operation of these components in a typical client device (such as an automobile in-vehicle system, a mobile computing platform, a non-mobile client system such as home or business computer network, and the like) with reference to FIGS. 3 and 4.

In the following discussion, computer and network devices, such as central service system 150, remote service and content providers 170, vehicle/client vendors 172, and client interface developer system 180 and client devices, such as mobile client devices 110 and non-mobile client devices 124 of FIG. 1, are described in relation to their function rather than as being limited to particular electronic devices and computer architectures. To practice the invention, the computer and network devices may be any devices useful for providing the described functions, including well-known data processing and communication devices and systems such as portions of in-vehicle computer systems, personal digital assistants, personal, laptop, and notebook computers and mobile computing devices with processing, memory, and input/output components, and server devices configured to maintain and then transmit digital data over a communications network. Similarly, the wired and wireless client devices may be any electronic or computing device for transmitting digital data over a wired or wireless network and are typically installed or resident within mobile vehicles such as automobiles, airplanes, ships, mobile computers and computing devices, and the like or in stationary structures such as houses or buildings utilized by businesses. Data, including client requests, service provider or carrier and content provider requests and responses, and transmissions to and from the central service system 150 and among other components of the human machine interface provisioning system 100, typically is communicated in digital format following standard communication and transfer protocols, such as TCP/IP, HTTP, HTTPS, FTP, IMAP and the like, or IP or non-IP wireless communication protocols such as TCP/IP, TL/PDC-P, WSP, Bluetooth, 802.11b, and the like, but this is not intended as a limitation of the invention. Additionally, the invention is directed toward provisioning of applications, such as user interfaces, within client computer systems, such as a network providing an telematic environment, but is not limited to a specific native language within the client devices, a particular function of an application, or a specific client configuration.

FIG. 1 illustrates an exemplary human machine interface provisioning system 100 configured to enhance the generation and deployment of applications, and in the illustrated example, user interfaces to mobile clients 110 and to non-mobile clients 124. The central service system 150 acts as a central repository for built and registered user interfaces and then deploys the user interfaces to the mobile and non-mobile clients 110, 124 via wireless network 140 and/or communication network 144 (such as the Internet, a LAN, a WAN, or other digital communications network). The central service system 150 includes a communication portal 152 for receiving messages from client interface developer systems 180 and clients 110, 124 (such as requests for user interfaces, services, or applications) and for transmitting copies of user interface (UI) descriptors 160 to clients 110, 124. A user interface repository 156 is provided to store received UI descriptors 158 from developer system 180, registered UI descriptors 160 (e.g., received descriptors 158 that have been further processed based on security and other validation rules 162), and security and deployment rules 162 (e.g., rules for registering received UI descriptors 158 and for use in deploying the registered UI descriptors 160 to clients 110, 124 with portal 152). A provisioning mechanism 166 is provided to register received UI descriptors 158 and to control deployment of registered UI descriptors 160 per the deployment rules 162. The operation of the central service system 150 is described in further detail below with reference to FIG. 2.

The system 100 includes a number of remote service and content providers 170 that are linked to the communications network 144 to provide services and content such as e-mail messaging, streaming media, navigational services, security and safety services, and other infotainment and/or telematics services to the clients 110, 124 directly or through the central service system 150. One or more vehicle or client vendor (such as an automobile manufacture or OEM) 172 is linked to the communications network 144 to provide the client interface developer system 180 with access to client signatures 176 stored in memory 174. The client signatures 176 allow users of the developer systems 180 to create user interfaces or other applications that are branded or tailored to the particular manufacturer or vendor of the client 110, 124 (e.g., provide a particular interface for an automobile to suit the needs or requirements of the vehicle design and its user interaction unit 118 and/or to suit the needs or requirements of the vendor such as by providing a standard look and feel (i.e., skin) for the particular vehicle 110). A client signature 176 typically includes a set of branding elements, skins, and component choices to be provided in each user interface and often a set of ergonomic rules for using these elements, skins, and components.

To support creation of applications or user interfaces, the system 100 includes one or more client interface developer systems 180 operable by developers or designers in building user interfaces and associated HMI applications with the confidence that the user interfaces and HMI applications will be suited to and compatible with a particular client 110, 124. This is achieved by the developer system 180 operating to generate the user interfaces and HMI applications based on the client signatures 176 and on the underlying communication and interaction rules or protocols of the system 100. As shown, the developer system 180 includes a network interface 182 for communicating with the vehicle/client vendors 172 to request and receive client signatures 176 and with the central service system 150 to deliver built UI interfaces (and in most cases, associated HMI applications) 196. A processor 184 is provided to control operation of the system 180 including running the interface editor 188 and data storage in the memory 190. The memory 190 stores the signatures 192 retrieved from the vendors 172 and built interfaces or UI descriptors and HMI applications 196 generated by the interface editor 188.

The interface editor 188 may be configured in a variety of ways to utilize the signatures 192 and formatting rules in building the interfaces or UI descriptors and HMI applications 196. In one embodiment, the editor 188 is a WYSIWYG drag and drop editor that is useful for hiding the complexity of the underlying formatting rules (such as the rules provided for creating a user interface descriptor based on XML). The editor 188 allows the designer or operator of system 180 to describe the user interface 196 with actions that each component will perform when the user interface is rendered at the client 110, 124. Preferably, the editor 188 is configured to support simulating the finished user interface to allow the developer to determine suitability and look and feel. Once finished, the built interface and/or HMI application 196 can be transferred or deployed to the UI repository 156 for storage at 158 where it can then be registered for use with a particular client 110, 124 and then stored as a registered UI descriptor 160 (and typically, an HMI application is associated with each UI descriptor and is stored at 160).

The system 100 acts to provision user interfaces (and/or HMI applications) to the clients 110, 124 that are generally any structures providing telematic technologies to a user. The mobile client 110 (such as a mobile computing device or platform including nearly any mobile computing device and mobile computing platforms such as those found in many automobiles, motorcycles, airplanes, and boats) is a wireless client and linked to the central service system 150 via wireless network 140. A hosting platform 114 is provided to receive, process, store, and deploy the UI descriptors and HMI applications 160 from the central service system 150 with a provisioning service 116. The UI descriptors and HMI applications 160 are passed to the user interaction unit(s) 118 for rendering or creation with the rendering service 120. The hosting platform 114 may also function as a bridge between other on board services 112 and the user interaction unit 118. Similarly, the non-mobile client 124 (such as a house or business building with a computing device, a computer system, or a network) is linked to the central service system 150 via either or both the wireless network 140 and the communications network 144 to receive the registered UI descriptors and HMI applications 160. The descriptors 160 are received, processed, stored, and deployed by the provisioning service 128 to the user interaction unit 134 for creation of a user interface(s) with the rendering service 136.

The provisioning system 100 of FIG. 1 is configured to allow third party developers using system 180 to generate applications (such as user interfaces and HMI applications) that can be easily downloaded and ran on clients 110, 124. FIG. 2 describes an exemplary operation of the system 100 by illustrating a provisioning process 200. The provisioning process 200 begins at 210 with the establishment of the communication links for the provisioning system 100. At this point, the central service system 150 establishes communication or makes itself accessible via the communications network 144 to the client interface developer system 180 and in some embodiments, to the remote service and content providers 170 and/or vehicle/client vendors 172. At 210, the central service system 150 has loaded the provisioning mechanism 166 and has stored the security and deployment rules 162 for use in registering received UI descriptors and HMI applications 158 and for deploying registered UI descriptors and HMI applications 160 to clients 110, 124.

Also at 210, an acceptable format for the built interfaces and HMI applications 196 is or has been established such that all such built interfaces and HMI applications 196 are readily deployable to the clients 110, 124 and more importantly, are useful in the two part construction of the user interface system of the clients 110, 124 (i.e., with the host platform 114, 126 running the HMI application and the rendering service 120, 136 of the user interaction units 118, 134 generating a user interface and receiving user inputs). In preferred embodiments, the hosting platform 114, 126 and the user interaction unit 118, 134 are designed to be independent from each other in terms of their operating systems (OS) and, in some cases, their native languages. For example, the host platform may utilize the Java™ programming language and the HMI application and provisioning service 116, 136 may be provided in Java™, but the user interaction unit 118, 134 may utilize Java or another programming language for the rendering service 120, 136. Based on these design goals, the system 100 generally utilizes a markup language including interaction rules for user interfaces and for communications between the hosting platform 114, 126 and the user interaction unit 118, 134.

In one embodiment, a markup language based on XML is utilized (sometimes labeled “vehicle user interface markup language” or simply VUML (although, of course, the markup language is applicable to all types of mobile clients as well as non-mobile clients). VUML includes an interaction mechanism (for messaging between the hosting platform 114, 126 and the user interaction unit 118, 134) described in relatively generic terms and a data presentation description. A single VUML message can be used to describe data presentation for multiple user interaction units 118, 134 (such as for a touch screen display or a voice-based system). The user interaction unit 118, 134 acts only to present the data to the user in a user interface and to get input from the user via the user interface and is not aware of the meaning of the data delivered in the VUML message. The user interaction unit 118, 134 is configured to understand the VUML message (sometimes referred to as a UI descriptor) and to implement a set of predefined user interface constructs or components. When a hosting platform 114, 126 sends a VUML or UI descriptor message to the user interaction unit 118, 134, each predefined construct or component is accompanied by the name or an identifier for the particular construct or component to allow the unit 118, 134 to readily render or change a user interface. User input messages returned from the units 118, 134 likewise identify input with the use of the construct or component identifiers or names.

Referring again to FIG. 2, the provisioning process 200 continues at 220 with the establishment of a repository 174 for client signatures 176. Typically, each vehicle or client vendor or manufacturer provides access to their signatures 176 but in some cases a single repository may be provided by a trusted third party or by the central service system. Access to the repository 174 is controlled by the vendors 172 and typically will involve one or more layers of security to be passed by developer systems 180 or the central service system 150. At 230, the vendors 172 receive a request from the client interface developer system 180 for a copy of one or more client signatures 176 for use in building a user interface or UI descriptor and/or HMI application. In some cases, such a request is transmitted to the central service system 150, which acts as an intermediary and then requests the signature 176 from the vendor 172. The signatures are typically stored in memory 190 at 192.

At 240, the developer or user of system 180 builds and stores an interface and, typically but not always, a corresponding HMI application 196 based on the received client signature 192 and the construction rules of the system 100 for interfaces (e.g., complying with the formatting and interaction rules such as by using VUML or other markup language and rules). In some embodiments, the built interfaces 196 are required to be described in XML. Typically, such interface creation at 240 would involve using the interface editor 188 (such as WYSIWYG drag and drop editor and/or a set of templates) to design a user interface describing the user interface using information in the client signature 192 (such as branding elements, skins, and component choices) along with selecting actions for each chosen component. In this manner, the developer is able to readily create a desired look and feel for a new user interface that is stored as a UI descriptor or built interface 196.

At 250, the developer system 180 transmits the built interface and HMI application 196 to the central service system 150 and the system 150 receives and stores the UI descriptor 158 in memory 156. At 260, the received UI descriptor and HMI application 158 is processed by the provisioning mechanism 166 based on security and deployment rules 162 to register the UI descriptor and HMI application 160. For example, when the clients 110 are automobiles, the UI descriptors and HMI applications 158 are registered for specific vehicle or group of vehicles based on security and applicability considerations such as level of authority or access provided to the developer system 180 for a particular vehicle and whether the UI descriptor and HMI application 158 are suitable for the particular vehicle or group of vehicles. Similar processes would be followed for client types and to support differing vendor requirements. Registration allows user interfaces to be reloaded and/or later distributed in clients 110, 124 and to be tracked or inventoried to allow the user interfaces and applications to be updated and otherwise maintained.

Once registered, the UI descriptor and HMI application are stored at 270 as a registered UI descriptor and HMI application 160 and are then scheduled for provisioning to target clients 110, 124. The provisioning mechanism 166 at 280 functions to download the registered UI descriptor(s) and HMI applications 160 to the clients 110, 124 typically based on a number of scheduling factors (which may be included in rules 162). For example, the mobile client 110 is typically moving for a period of time and stationary for a period of time, which may lead to the client 110 being in and out of contact or connection with the wireless network 140 or the type of connectivity with network 140 may not be appropriate for downloading a UI descriptor and HMI application 160. In these cases, the provisioning mechanism or server 166 can employ heuristics based on factors including connectivity parameters and the present operation of the mobile client 110 to determine when to download the UI descriptor and HMI application 160 (such as waiting until the client 110 is stationary but still operating and the like). At 290, the clients 110, 124 receive the UI descriptor and HMI application 160 and a provisioning service 116, 128 in the hosting platform 114, 126 operates to transmit the new UI descriptor to the appropriate user interaction unit 120, 134, which, in turn, operates its rendering service 120, 136 to parse the received UI descriptor and to generate a new user interface within the client 110, 124.

FIG. 3 illustrates a human user interface system 300 that provides more detail on the functional components of a hosting platform 310 and a user interaction unit 340 and the communications between these devices. As shown, the hosting platform 310 includes a CPU 312 and provides a bridge to other client services 316 with inputs from these other devices shown at 318. The hosting platform 310 includes a communication manager 330 for handling communications with the user interaction unit 340 including transferring UI descriptors 370 (such as XML messages) and UI presentation instructions 378 and receiving user input messages 374. The hosting platform 310 may take many configurations to practice the invention such as a telematics communications unit (TCU) as provided by vendors including Motorola, Inc., a vehicle consumer services interface (VCSI) as provided by vendors including Ford Motor Company, a vehicle service gateway device, and other similar devices and systems.

The hosting platform 310 runs a human machine interface (HMI) application(s) 314 that acts as a server to the thin client user interaction unit 340. The HMI application 314 implements the key application logic necessary for processing the user inputs 374 and generating UI presentation instructions 378 for each UI descriptor 322. The HMI application 314 controls access to the other shared client services 316 by a user via the user interaction unit 340. Storage 320 is provided in the platform 310 (or at a location accessible by the platform 310) in which received UI descriptors 322 are stored along with communication protocols and, if appropriate, interaction rules 326. In one embodiment, the protocol 326 (e.g., the VUML protocol) is a set of XML or other markup language messages that encapsulate user interface events, control events, and system events. The HMI application 314 maintains a detailed reference (not shown) in storage 320 of user interfaces 364 on the user interaction unit 340. The HMI application 314 can provision UI descriptors 322 when received or thereafter using the UI descriptor (e.g., XML messages) messages 370.

The user interaction unit 340 provides a physical interface between a user and may include haptic (touch and feedback) interface areas or displays, visual displays, audio output and input including speed-based user interfaces, and many other types of physical embodiments of user interfaces. Additionally, the user interaction unit 340 is a relatively thin client architecture device with software and/or hardware devices for limited functionality (such as understanding the UI descriptors 370, generating user interfaces 364, and receiving user input 368). As shown, the user interaction unit or HMI device 340 includes a communication manager 342 for receiving UI descriptors 370 and UI presentation instructions 378 (e.g., markup language messages such as XML messages) and transmitting user inputs 374 (e.g., markup language messages such as XML messages) to the host platform 310 on behalf of the controller or processor 344 and UI rendering engine 350. The communication protocol used (such as protocols 326) may be any of a number of protocols but in one embodiment, the communication protocol is a protocol based on a markup language, and in one preferred embodiment, an XML-based communication protocol is chosen. Markup language protocols are useful because they are typically independent from underlying transport protocols used to transmit the messages 370, 374, and 378 in digital form between the hosting platform 310 and the user interaction unit 340. Developers of UI descriptors 322 do not need knowledge of how the platform 310 and unit 340 are communicatively connected. In most embodiments, the messaging between the platform 310 and unit 340 can be both synchronous and asynchronous and in XML applications, the communication protocols 326 may include document type declarations (DTDs) or XML schemas (or references thereto) defining the formatting and content of the messages 370, 374, 378.

The UI rendering engine 350 is provided on the user interaction unit 340 to act as a life cycle manager and to create or run user interfaces 364. The UI rendering engine 350 may be written in a native language and includes a kernel 352 for controlling component linking, processing user input 368 via the user interface 364, and running a descriptor parser 354 for parsing or understanding UI descriptor messages 370 stored at 358 on UI rendering engine 358 or elsewhere on user interaction unit 340. A UI component repository 360 is provided to store components or constructs anticipated to be used by the particular user interaction unit 340 in generating and running user interfaces 364. Examples of defined components or constructs include buttons (such as for power control, to map to voice commands, and often are able to send user input messages 374 to the companion HMI application 314), labels, lists, tables, dialog boxes, clocks, speech engine indicators, and many more useful devices for user interfaces 364. The components in the repository 360 are preferably updateable to allow components to be periodically modified and added for use or to called for by UI descriptors 358. For example, if a particular type of button, panel, or skin element was specified to be available on the user interaction unit 340, the UI rendering engine 350 stores the new component in the UI component repository 360. The formatting or construction rules for the registered UI descriptors 160 of FIG. 1 allow for a wide variety of components to be used and called for by the descriptors 160. The dynamic component function of the UI rendering engine 350 can be provided in a number of ways and will depend on the underlying native language (for example, in Java™, the components in the repository 360 could be jar files). The rendering engine 350 functions to understand the UI descriptor message 370 and to generate a user interface 364 based on the received and parsed UI descriptor 358 (e.g., an XML document). The function of the system 300 will now be discussed with reference to FIG. 4.

FIG. 4 illustrates a user interface rendering process 400 provided by the system 300 of FIG. 3. Initially, at 404, one or more HMI applications 314 are installed in the hosting platform 310 to configure the platform 310 for provisioning and rendering user interfaces (or other applications) on the user interaction unit 340. Note, a particular HMI application 314 and one or more user interaction units 340 function in combination to present a user interface 364 on the unit 340 based on a received UI descriptor 322 (e.g., an XML or other markup language document), to process user input 368, and to change the user interface 364 as appropriate based on the user input 368. At 410, a set of components is stored on the user interaction unit 340 in UI component repository 360. At 416, the hosting platform 310 receives a new UI descriptor (such as over a wired or wireless network 144, 140 from control service system 150 of FIG. 1). At 420, the HMI application 314 is called up (or is already running) on platform 310 and acts to store the UI descriptor 322, to generate a UI descriptor message per communication protocols 326, and transmits the UI descriptor message 370 (such as an XML-based message) to the user interaction unit 340.

At 424, the UI rendering engine 350 reads the UI descriptor 358 with parser 354 and at 430, creates a specific set of user interfaces 364 using a specific language and based on currently stored components in the UI component repository 360 and the parsed UI descriptor 358. Rendering of user interfaces 364 generally includes mapping objects or elements of the parsed UI descriptor 358 to the components or constructs in the repository 360. For example, in embodiments where the UI descriptor 358 is an XML or other markup language document, the objects (e.g., VUML objects) are mapped by the UI rendering engine 350 directly onto the language dependent user interface constructs in repository 360. For a unit 340 providing a graphical user interface, this may include panels, form, dialog boxes, buttons, drop down lists, and the like.

For a non-visual interface, the mapping is more complex and can be handled in a number of ways. In one embodiment, a generic hierarchy of command and response categories and their respective actions fro each type of user interface is defined and accessed by the UI rendering engine 350 (such as in repository 360 or stored as communication protocols 326 on unit 340 or elsewhere) such that any particular user interaction unit 340 interaction or rendering can be described using the same constructs stored in repository 360 for different user interaction units 340, which allows a particular construct to be matched to the relevant user interaction unit 340. For example, in a speech-based user interaction unit 340, three components are typically provided including a speech recognition engine, a speech synthesis engine, and a dictation engine (which captures speech and renders it to text form without interpreting commands). In a haptic (i.e., touch and feel) user interaction unit 340, the unit 340 is simplified using a set of feedback (similar in many ways to those found in video game systems) directed to specific areas of a client device (e.g., in an automobile, the areas may include the shift stick, steering wheel, seat, and the like). Feedback sensory mechanisms at these areas (i.e., part of the user interface 364) accentuate the interaction with the client device (e.g., the automobile, the mobile computing device, the home network, and the like). For example, an automobile may include a steering wheel with a user interface 364 that provides collision avoidance feedback such that when the automobile senses another vehicle in a blindside of the vehicle the steering wheel may provide feedback such as vibrating. For these types of user interaction units 340, the UI descriptor 358 is targeted or designed specifically for these client device components and the feedback actions the components produce or cause. The specification for the user interaction unit 340 may define the set of components stored at 410 but the set can typically be changed. In some embodiments, multiple user interfaces are stored in a repository and then simply loaded rather than rendered as needed (such as storing a diagnostic interface that can be called up and run on an as needed basis).

At 436, the UI rendering engine monitors the user interface(s) 364 for user inputs 368 and receives and processes such inputs 368. In some cases, such as simply switching screens, navigation, and the like, the UI rendering engine 350 (by following the UI descriptor 358) acts to modify the user interface 364 based on the user input 368. For more complex inputs or processing, the UI rendering engine 350 at 440 transmits via its communication manager 342 user input messages 374 (e.g., markup language, such as XML, messages) to the HMI application 310 on the hosting platform 310 describing the raw user input 368. At 450, the HMI application 314 processes the user input 368 as defined in message 374 and, if appropriate, transmits a UI presentation instruction(s) 378 (again, typically a markup language message such as an XML message as defined or required by communication protocols 326) to the user interaction unit 340. The UI rendering engine 350 at 460 processes the UI presentation instruction 378 and changes the user interface 364 as appropriate based on executed presentation instructions (such as displaying a message on the user interface 364, synthesizing a voice message, altering the display on the user interface 364, and many more actions). In the above manner, the user interaction unit 340 can be implemented with relatively thin and simplified architecture with more complex processing being performed by the hosting platform 310 and a wide variety of user interfaces 364 can be pushed out to clients as the architecture of the system 300 provides significant flexibility and, at the same time, higher levels of standardization of the functioning components (i.e., the UI rendering engine 350 and HMI application 314).

As will be appreciated, the look and feel of the user interface 364 will vary between user interaction units 340 (although any user interaction unit 340 supporting the UI descriptors of the invention can implement nearly all UI descriptors 358). Such “branding” is achieved by loading different constructs or components in the UI component repository 360 to create different user interfaces 364 and react to user input 368 differently as determined by the UI rendering engine 350 based on the UI descriptor 358 or by the HMI application 314 corresponding to the UI descriptor 358.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed. For example, UI descriptors and HMI applications can be delivered as a single package to the hosting platform 310 (such as by central service system 150), such as two bundles configured as open services gateway initiative (OSGi™) bundles. Upgrades can later be performed separately or concurrently for the UI descriptor and the corresponding HMI application. In these embodiments, the hosting platform 310 would be configured to support a set of APIs set forth in the OSGi™ specification.

In many cases, the HMI application 314 processes the user inputs message 374 (e.g., an XML message) describing the user input 368 and determines that other shared client services 316 need to be utilized and takes the necessary actions to call the services 316. For example, the user interface 364 may accept input 368 an indication that a user wants to make a call, and the HMI application 314 may process the input in message 374 and then take actions to have the other shared client service 316 make the call. In this manner, the HMI application 314 provides a bridge or link between the user and the user interaction unit 340 and the other shared devices 316.

We claim:

1. A system in a client device for providing user interfaces to a user of the client device, comprising:
a hosting platform including an interface application processing user inputs and in response, generating user interface presentation instructions; and
a user interaction unit in communication with the hosting platform including a user interface engine generating a user interface, receiving the user inputs from the user, generating a user inputs message based on the user inputs, and executing the user interface presentation instructions to modify the user interface.

2. The system of claim 1, wherein the hosting platform receives a user interface descriptor defining a user interface construction from a source external to the client device and transmits the user interface descriptor to the user interaction unit for use in generating the user interface.

3. The system of claim 2, wherein the user interface descriptor is a markup language document.

4. The system of claim 3, wherein the markup language document is an eXtensible Markup Language (XML) document and wherein the user inputs message and the interface presentation instructions are XML-based messages.

5. The system of claim 2, wherein the user interaction unit further includes a repository storing a set of component definitions and wherein the generating of the user interface includes parsing the user interface descriptor and then mapping elements of the user interface descriptor to the component definitions.

6. The system of claim 2, wherein the interface application is a human machine interface application configured for use with the user interface descriptor.

7. The system of claim 6, wherein the interface application processes the user inputs based on a set of interaction protocols.

8. The system of claim 1, wherein the interface application is in communication with shared services of the client device and generates messages to the shared services based on the processed user inputs.

9. A computer-based method for providing a user interface, comprising:
providing a user interface rendering engine with a parser;
storing a set of interface components defining user interface elements;
receiving a user interface descriptor;
parsing the user interface descriptor with the parser of the user interface rendering engine; and
generating a user interface based on the parsed user interface descriptor and the set of interface components.

10. The method of claim 9, further including monitoring the user interface for user inputs and generating a user inputs message based on the user inputs.

11. The method of claim 10, further including receiving a user interface presentation instruction in response to the user inputs message generating and executing the user interface presentation instruction with the user interface rendering engine to modify the user interface.

12. The method of claim 11, wherein the user interface descriptor is a markup language document with objects corresponding to a subset of the interface components and wherein the user interface generating includes mapping the objects to the interface components.

13. The method of claim 12, wherein the markup language is XML and further wherein the user inputs message and the user interface presentation instruction are XML-based messages.

14. The method of claim 9, further including after the user interface generating, receiving an additional user interface descriptor and repeating the parsing and the generating for the additional user interface descriptor to create a new user interface based on the set of interface components.

15. The method of claim 9, further including receiving a replacement set of interface components defining the user interface elements and in response, storing the replacement set and repeating the user interface generating for the parsed user interface descriptor based on the replacement set.

16. A computer-based method for use in providing a user interface within a client system, comprising:
transmitting a user interface descriptor providing user interface components to a user interaction unit;
receiving a message from the user interaction unit providing user input information based on user input through a user interface created based on the user interface descriptor;
processing the user input message based on a set of interaction rules;
generating a user interface presentation instruction defining modifications to the user interface; and
transmitting the user interface presentation instruction to the user interaction unit for execution.

17. The method of claim 16, wherein the user interface descriptor is received from a source external to the client system and comprises a markup language document.

18. The method of claim 17, wherein the user interface descriptor is an XML document and is received over a wireless network.

19. The method of claim 16, wherein the set of interaction rules define responses to the user input corresponding to the provided user interface components.

20. The method of claim 16, further including based on the processing, generating and transmitting a message based on the user input information to a shared client service in the client system.

21. The method of claim 16, wherein the user input message and the user interface presentation instruction are markup language messages.

22. A method for provisioning user interfaces to client devices linked to a central service system by a digital communication network, comprising:
providing a repository storing client signatures, wherein each of the client signatures defines user interface elements for a particular one of the client devices;
retrieving a client signature from the repository; and
building a user interface descriptor having a predefined format based on the retrieved client signature.

23. The method of claim 22, further including registering the built user interface descriptor for deployment to a set of the client devices corresponding to the retrieved client signature based on a set of security and deployment rules.

24. The method of claim 23, further including transmitting the registered user interface descriptor to one of the client devices over the digital communication network, the one client device including a hosting platform for receiving the registered user interface descriptor and for transmitting the received user interface descriptor to a human machine interface unit.

25. The method of claim 24, wherein the registered user interface descriptor is a markup language document.

26. The method of claim 22, further including installing a user interface rendering engine on a human machine interface device on the client devices adapted for generating a user interface based on the built user interface descriptor and a human machine interface application on a hosting platform on the client devices adapted for processing user inputs to the user interface to provide user interface presentation instructions to the user interface rendering engine.
